(19) United States
(12) Patent Application Publication
(10) Pub. No.: US 2003/0054807 A1
(43) Pub. Date: Mar. 20, 2003

(54) Apparatus, and associated method, for facilitating multicast and broadcast services in a radio communication system

(76) Inventors: Liangchi Hsu, San Diego, CA (US); Mark W. Cheng, San Diego, CA (US); Zhigang Rong, Irving, TX (US); Lin Ma, Irving, TX (US)

Correspondence Address: Docket Clerk, P.O. Box 802432, Dallas, TX, 75380, US

(21) Appl. No.: 10/235,332

(22) Filed: Sep. 5, 2002

Related U.S. Application Data
(60) Provisional application No. 60/322,698, filed on Sep. 17, 2001.

(51) Int. Cl. H04M 3/42

(52) U.S. Cl. 455/414; 455/412

(57) ABSTRACT

Apparatus, and an associated method, for facilitating effectuation of a multicast and broadcast communication service in a CDMA 2000, or other radio, communication system. A broadcast service parameter message generator generates messages including separate parts, one part common to all of the transport channels, and a second part common to less than all of the transport channels. A frame transmitter and frame detector operates pursuant to a modified H-ARQ communication scheme and, a set comparator is provided for the mobile stations operable in the communication system by which to determine a multicast active set of base transceiver stations to which the mobile station tunes to receive the data forming the multicast and broadcast communication service.

### CROSS-REFERENCE TO RELATED APPLICATIONS

The Present application claims the priority of provisional patent application No. 60/322,698, filed on Sep. 17, 2001.

The present invention relates generally to a manner by which to provide multicast and broadcast services (MBS) in a cellular, or other, radio communication system. More particularly, the present invention relates to apparatus, and an associated method, by which to facilitate multicast and broadcast services in which two or more transport channels, such as an 1xRTT transport channel and a 1xEV-DV transport channel, are together used to communicate the data needed to effectuate the MBS.

Layered messages, including separate parts, a first part common to all of the transport channels and a second part common to one of the transport channels, are defined. Additionally, an enhanced H-ARQ scheme is provided for communication of the MBS data. And, a cell selection scheme is provided.

Improved communication capacity, as well as improved flexibility of communication are provided for a CDMA 2000, or other radio, communication system.

### BACKGROUND OF THE INVENTION

Use of communication systems through which to communicate data between two, or more, locations is an endemic part of modern society. Communication stations are positioned at the separate locations and operate to effectuate the communication of the data.

In a minimal implementation, the communication system is formed of a first communication station, forming a sending station, and a second communication station, forming a receiving station. A communication channel interconnects the communication stations. Data that is to be communicated by the first communication station to the second communication station is converted, if necessary, into a form to permit its communication upon the communication channel. And, the second communication station operates to detect the data communicated thereto by the first communication station and to recover the informational content thereof.

In a radio communication system, the communication channel that interconnects the sending and receiving stations is formed of a radio channel, defined upon a radio link, formed upon the electromagnetic spectrum. Other, conventional communication systems generally require a fixed, wireline connection extending between the communication stations upon which to define communication channels.

As a radio link, rather than a wireline connection, is utilized upon which to define the communication channels, the need otherwise to utilize wireline connections upon which to define the communication channels is obviated. As a result, installation of the infrastructure of the radio communication system is generally less costly than the corresponding costs that would be required to construct a conventional, wireline communication system. And, mobility of the communication station can be provided, thereby to permit a radio communication system to form a mobile radio communication system.

A cellular communication system is an exemplary type of radio communication system. Cellular communication systems have been widely implemented and have achieved wide levels of usage. A cellular communication system provides for radio communications with mobile stations. The mobile stations permit telephonic communication to be effectuated therethrough. And, mobile stations are generally of sizes to permit their carriage by users of the mobile stations.

A cellular communication system includes a network part that is installed throughout a geographical area and with which the mobile stations communicate by way of radio channels defined upon radio links allocated to the communication system.

Base transceiver stations, forming portions of the network part of the communication system, are installed at spaced-apart locations throughout the geographical area that is to be encompassed by the communication system. Each of the base transceiver stations defines a cell, formed of a portion of the geographical area. And, the term cellular is derived from the cells defined by the base transceiver stations.

When a mobile station is within the cell defined by a base transceiver station, communications are generally effectuable with the base transceiver station that defines the cell. As a mobile station travels between the cells defined by different ones of the base transceiver stations, communication handoffs are effectuated to permit continued communications by, and with, the mobile station. Through appropriate positioning of the base transceiver stations, the mobile station, wherever positioned within the geographical area encompassed by the cellular communication system, shall be within close proximity of at least one base transceiver station. Therefore, only relatively low-powered signals need to be generated to effectuate communications between a mobile station and a base transceiver station. Hand-offs of communications between successive base transceiver stations, as the mobile station moves between cells, permit the continued communications without necessitating increase in the power levels at which the communication signals are transmitted. And, the low-power nature of the signals that are generated permit the same radio channels to be reused at different locations of the cellular communication system. Efficient utilization of the frequency-spectrum allocation to the cellular communication system is thereby possible.

Cellular, as well as various other, communication systems are constructed to be operable pursuant to an appropriate operating specification. Successive generations of operating specifications have been promulgated. And, corresponding generations of cellular communication networks have been installed throughout wide areas to permit telephonic communications therethrough. So-called first-generation and second-generation cellular communication networks have been widely implemented and have achieved significant levels of usage. And, installation of so-called third-generation and successor-generation systems have been proposed. An exemplary operating specification, referred to as the CDMA 2000 specification, sets forth the operating parameters of an exemplary, third-generation communication system. The CDMA 2000 operating specification, as well as other third-generation operating specifications, provide for packet-based data communication services. The CDMA 2000 operating specification provides for high data rate communication services to be effectuated therethrough. Amongst the communication services that shall be available are multicast and broadcast services (MBS) in which data sourced at a data source connected, or otherwise coupled, to the network infrastructure of the communication system is communicated to permit its detection and viewing at one or more mobile stations. Such services are also referred to herein as broadcast and multicast services (BCMCS). Such communication services, generally, are data intensive.

Various technical aspects of such multicast and broadcast services remain. Solutions and standardized procedures by which to implement such solutions are undergoing ongoing consideration.

Proposals for inclusion in the operating specification for the aforementioned CDMA 2000 communication system, for instance, include various technology proposals by which to effectuate the communication of data at high data rates. One general category of proposal is referred to as the 1xRTTT technology and another is the 1xEV-DV technology. Other proposals for the CDMA 2000 system, as well as other proposals for manners by which to effectuate multicast and broadcast services in other third-generation communication systems have also been set forth. Various technical aspects of effectuation of the multicast and broadcast services therein analogously remain to be resolved.

It is in light of this background information related to multicast and broadcast services in a radio communication system that the significant improvements of the present invention have evolved.

### SUMMARY OF THE INVENTION

The present invention, accordingly, advantageously provides apparatus, and an associated method, by which to provide multicast and broadcast services (MBS) in a cellular, or other, radio communication system.

Through operation of an embodiment of the present invention, a manner is provided by which to facilitate the MBS in which two or more transport channels are together used to communicate the data needed to effectuate the multicast and broadcast service.

Messages that are formed to facilitate the effectuation of the MBS are layered formed of at least two parts. A first part is common to all of the transport channels. And, a second part is common to one of the transport channels. An enhanced H-ARQ (hybrid-automatic request) mechanism is provided by which to facilitate packet retransmission of data communicated to effectuate the MBS. A forward link soft combining scheme is further provided in which a multicast active set is defined of base transceiver stations through which a mobile station can selectively be tuned to receive the MBS. And, a scheduling scheme is provided to permit simultaneous data and voice communications to be effectuated together with the multicast and broadcast service.

In one aspect of the present invention, a message generator generates a broadcast/multicast service parameter message. The message generator generates broadcast/multicast service parameter messages for communication to mobile stations pursuant to effectuation of the multicast and broadcast services that are to be effectuated therewith. The multicast and broadcast service messages are layered in construction. That is to say, the messages are formatted to include separate fields. A first field includes common service parameters, common to all of the channels upon which the data forming the multicast and broadcast service is to be communicated. And, the messages are formatted to include an additional field, or fields, containing parameters specific to the individual transport channels upon which the data is or is to be, communicated.

Common service parameters include, for instance, parameters identifying multicast group information, mapping information, and channel-type information.

Transport channel-specific parameters include, for instance, a channel-code indication, a data rate indication, a coding level indication, a frame size indication, and a repetition number indication.

In another aspect of the present invention, enhanced H-ARQ procedures are utilized. Due to the nature of a multicast and broadcast service, delivery acknowledgment of a data packet to each of the mobile stations that receives the multicast and broadcast communication service. Stop-and-wait retransmission procedures form a simple, repetitive procedure. Operations at the mobile station are dependent upon whether the sequence number corresponds to the sequence number of a previously-delivered data or whether the sequence number corresponds to a newly-indicated sequence number. Responsive to determinations made at the mobile station of the sequence number, the data packet is determined either to be a new data packet or a redundant data packet. CRC (cyclic redundancy code), or other parity-checking mechanism, and the data packet is selectably passed to a higher logical-level layer of the mobile station to which the data is delivered.

In another aspect of the present invention, a modified, fast cell site selection (FCCS) technique is provided. The technique does not require the use of feedback information in the determination of an eligible set of base transceiver stations. A multicast active set is determined by a mobile station. The multicast active set is a selected subset of base transceiver stations, selected from stored indications of an active set and indicia provided to the mobile station as part of a multicast and broadcast message.

In another aspect of the present invention, support is provided to permit the effectuation of simultaneous data and voice communication services and multicast and broadcast communication services. MUX PDUs include formatted portions that identify the type of data that is contained in a data segment. Through appropriate detection of the values of the data part, the type of data is determinable at the mobile station and appropriate actions are performed thereon.

In one implementation, multicast and broadcast services are provided in a CDMA 2000, cellular communication system. The communication service is effectuable upon flexible transport channels including, for instance, a 1xRTT-defined channel and a 1xEV-DV-defined channel. A broadcast service parameter message is defined and selectably communicated to mobile stations that are to receive the multicast and broadcast communication service. The data communicated pursuant to the communication service utilizes a modified H-ARQ retransmission scheme that does not require feedback from the mobile stations. And, the system provides for a modified fast cell site selection scheme that permits the mobile station to select a multicast active set of base transceiver stations from which to receive the data communicated pursuant to the communication service.

In these and other aspects, therefore, apparatus, and an associated method, is provided for a radio communication system. The communication system is at least selectably operable to effectuate a broadcast of data pursuant to a broadcast service to a first mobile station and at least a second mobile station. The radio communication system selectably defines a first transport channel and at least a second transport channel that extend between the network infrastructure of the radio communication system and the first and at least second mobile stations. Communication of the data upon the first and at least second transport channels is facilitated. A message generator is coupled to the network infrastructure. The message generator generates a broadcast service parameter message selectably for broadcast to the first and at least second mobile stations. The broadcast service parameter-message selectably contains a common parameter field and a channel-specific field. The common parameter field is selectably populated with at least a first common-service parameter, common to the first and at least second transport channels. And, the channel-specific parameter field is selectably populated with at least a first channel-specific parameter, common to less than all of the first and at least second transport channels.

A more complete appreciation of the present invention and the scope thereof can be obtained from the accompanying drawings that are briefly summarized below, the following detailed description of the presently preferred embodiments of the invention, and the appended claims.

### BRIEF DESCRIPTION OF THE DRAWINGS

FIG. 1 illustrates a functional block diagram of an exemplary radio communication system in which an embodiment of the present invention is operable.

FIG. 2 illustrates a functional representation of an exemplary transport channel structure defined pursuant to an embodiment of the present invention.

FIG. 3 illustrates a representation of the message structure of a broadcast/multicast service parameter message generated pursuant to operation of an embodiment of the present invention.

FIG. 4 illustrates a message sequence diagram representative of signaling generated during operation of the radio communication system shown in FIG. 1.

FIG. 5 illustrates a representation of a forward shared channel defined in the radio communication system shown in FIG. 1.

FIG. 6 illustrates a process diagram illustrating operation of an embodiment of the present invention by which a modified H-ARQ scheme is utilized pursuant to communication of data packets to perform a multicast and broadcast service.

FIG. 7 illustrates a representation of the relationship between a multicast active set of base transceiver stations defined pursuant to an embodiment of the present invention, formed of one or more base transceiver stations of the radio communication system shown in FIG. 1.

FIG. 8 illustrates a further embodiment of the present invention.

FIG. 9 illustrates a message sequence diagram illustrating exemplary 1xEV-DV BCMCS mode switching.

FIG. 10 illustrates a message sequence diagram illustrating exemplary mode switching out of a dedicated mode of operation into a shared mode of operation.

FIG. 11 illustrates a message sequence diagram illustrating mode switching out of a shared mode of operation and into a dedicated mode of operation.

FIG. 12 illustrates a representation of two BCMCS repetition schemes pursuant to an embodiment of the present invention.

FIG. 13 illustrates a partial functional block, partial message flow, diagram representative of BCMCS cell switching operations performed pursuant to an embodiment of the present invention.

FIG. 14 illustrates an exemplary scheme by which to recover missing data frames subsequent to cell switching operations performed pursuant to an embodiment of the present invention.

### DETAILED DESCRIPTION

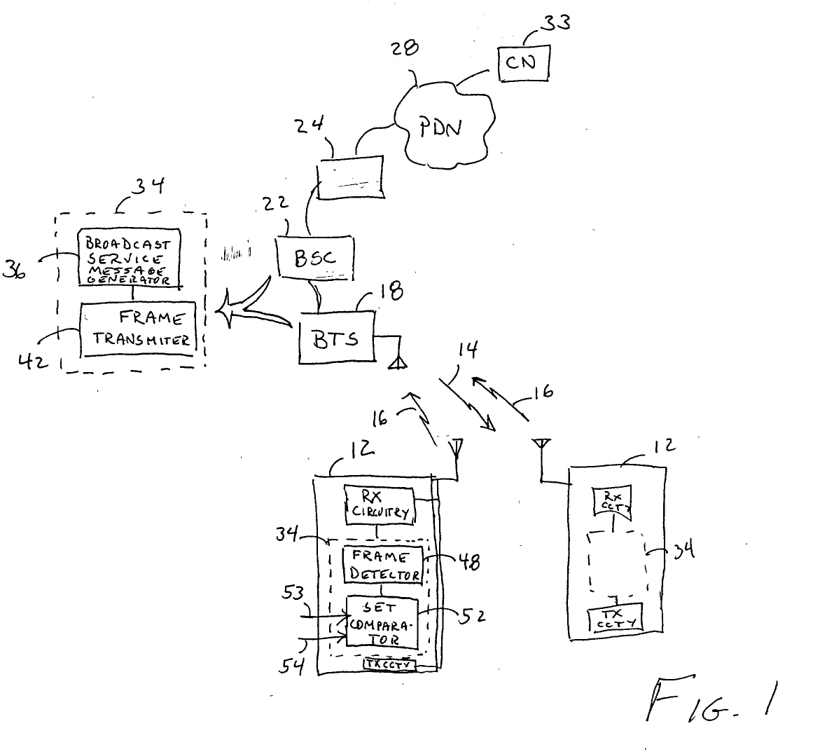

Referring first to FIG. 1, a radio communication system, shown generally at 10, provides for radio communications with mobile stations, of which two mobile stations 12 are shown in the figure. In the exemplary implementation, the communication system forms a cellular communication system operable, generally, pursuant to a CDMA 2000, cellular operational specification. The teachings of the present invention are, however, also implementable in any of various other types of communication systems in which multicast and broadcast communication services are implemented. Accordingly, while the following description shall describe operation of an embodiment of the present invention with respect to its implementation in a CDMA 2000 communication system, the present invention is analogously also operable in other types of communication systems.

The mobile stations 12 communicate by way of radio links with a network part of the communication system. The radio links are represented here by a forward link 14 and reverse links 16. While, for purposes of illustration, only a single forward link 14 is shown, representative of a multicast or broadcast communication service, point-to-point communication services are also effectuable during operation of the communication system. Radio channels are defined upon the forward and reverse links. And, more particularly, data, communicated pursuant to effectuation of a multicast and broadcast service, is communicated upon selected communication channels defined upon the forward link 14.

A network part of the communication system includes a base transceiver station (BTS) 18. Both the base transceiver station and the mobile station form radio transceivers capable of transducing radio signals therebetween by way of radio channels defined upon the forward and reverse links 14 and 16. The base transceiver station forms part of a radio access network portion of the network part of the communication system. And, the radio access network part of the communication system is here shown further to include a base station controller (BSC) 22 and point control function (PCF) and a packet data service node (PDSN) 24. The BSC is coupled between the base transceiver station and the PDSN.

The PDSN forms a gateway with a fixed-network part, here represented by a packet data network (PDN) 28. A correspondent node (CN) 33 is coupled to the network 28 and is representative of a communication node with which communications are effectuable with the mobile stations 12. The correspondent node is formed, for example, of a content server at which data that is to be multicast or broadcast to the mobile station is sourced.

The network part of the communication system includes apparatus 34 of an embodiment of the present invention. The apparatus is implemented at any desired location of the network part, such as, here, at the base station controller or base transceiver station, or distributed therebetween. The apparatus 34 includes a broadcast service parameter message generator 36 that operates to generate broadcast service parameter messages formed pursuant to an embodiment of the present invention. The messages generated by the generator, once formed, are sent by the base transceiver station by way of a radio channel defined upon the forward link 14 to the mobile stations 12.

In the exemplary implementation in which the CDMA 200 system provides 1xEV-DV capabilities, multicast and broadcast communication services provided pursuant to operation of the communication system utilize a forward shared packet data channel defined upon the radio link 14 together with a forward supplemental channel, also defined upon the radio link 14, by which to effectuate the communication service. That is to say, the multicast and broadcast service is effectuated, at least selectably, upon two or more transport channels.

The data that is to be multicast and broadcast pursuant to the MBS communication service is formatted by a frame transmitter 42 that also forms a portion of the apparatus 34 of an embodiment of the present invention. The frame transmitter operates to transmit frames of the data to effectuate the communication of the MBS data service. The frame transmitter also operates pursuant to a modified, H-ARQ retransmission scheme, selectably to retransmit data frames or packets responsive to certain conditions.

The mobile stations also include apparatus 34 of an embodiment of the present invention. An exemplary one of the illustrated mobile stations is here shown to include such apparatus. Others of the mobile stations analogously also include such structure. The apparatus 34 positioned at the mobile station is here shown to include a frame detector 48. The frame detector forms part of, or is coupled to, the receive part of the mobile station. And, the frame detector operates to detect the frames transmitted by the frame transmitter pursuant to the broadcast of the data to effectuate the MBS communication service. The frames that are transmitted by the frame transmitter have associated therewith sequence numbers that are detected by the frame detector. Responsive to the detected values of the sequence numbers of the frames detected by the frame detector, further action is taken at the mobile station, such as to soft-combine values of frames or to pass the values of the detected frame to a higher logical-layer of the mobile station.

The apparatus 34 positioned at the mobile station further includes a set comparator 52. The set comparator operates to compare indications of identities of base transceiver stations of the network part of the communication system and to receive indications of an active set of base transceiver stations earlier provided to the mobile station, and indications of which are stored at the mobile station. The set comparator operates to determine a multicast active set of base transceiver stations to which the mobile station tunes to receive the data to effectuate the MBS communication service. The lines 53 and 54 are representative, respectively, of the input of the indications to the set comparator and responsive to which the set comparator performs the comparison operations.

The mobile stations 12 further operate pursuant to data and voice operation. In the exemplary implementation, both the MBS communication service and the data and voice communication services are effectuable simultaneously. Through appropriate designation of selected bits of header parts of frame-formatted data communicated to the mobile station, a ready determination is made as to what communication service the data forms. And, appropriate additional action to operate upon the data are made responsive thereto.

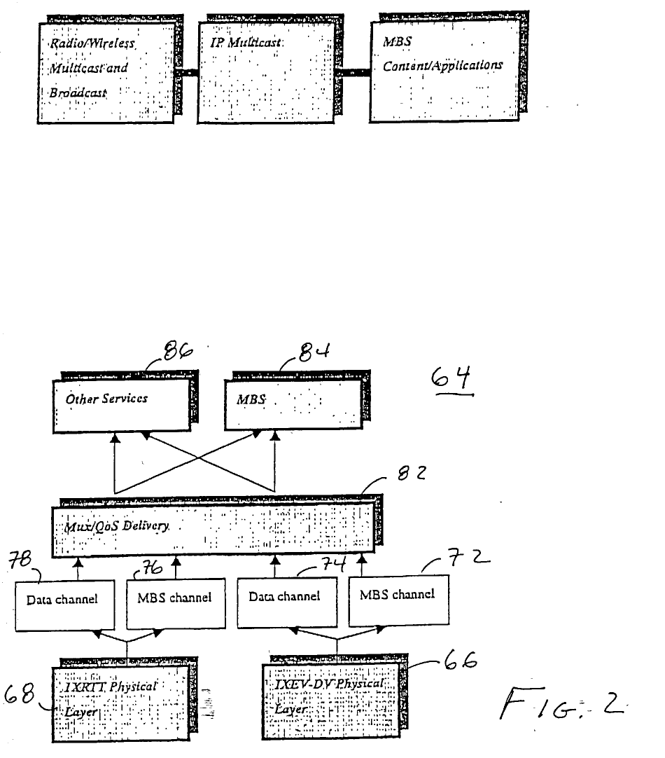

FIG. 2 illustrates an exemplary flexible transport channel structure, shown generally at 64, defined pursuant to an embodiment of the present invention and pursuant to which the apparatus 34, shown in FIG. 1, operates. The channel structure includes a physical layer, here in the exemplary implementation, a 1xEV-DV physical layer 66 and a 1xRTT physical layer 68, as defined in the CDMA 2000 operating specification, or proposed variant thereof. The 1xEV-DV physical layer defines an MBS (multicast and broadcast service) channel 72 and a data channel 74 upon which to communicate, respectively, MBS data and voice and other data. Analogously, the 1xRTT physical layer 68 defines both an MBS channel 76 and a data channel 78. Data to effectuate MBS and data/voice services, respectively, is communicated upon the respective channels to be delivered to the mobile station, here to be delivered in a multiplexed or QoS (quality of service)-dependent manner, indicated by the block 82. And, thereafter, the data of the associated services are provided to an MBS layer 84 or in another services layer 86 thereby. And as indicated by the segments 88, data delivered by way of the channels defined by either of the physical layers 66 and 68 are provided to the appropriate layer 84 or 86. Because channels defined, selectably, upon both of the 1xEV-DV and 1xRTT physical layers are utilized to effectuate communication services, improved capacity, and flexibility, of communications are permitted. And, here, the 1xEV-DV, forward-shared packet-data channel is shared by high-speed packet data users based upon code or time multiplexing. The channel is used here also for MBS information delivery.

With such channel designations, the MUX/QoS delivery layer 82 must be able to differentiate between the data channels 74 and 78 and the MBS channels 72 and 76 upon which the respective data is communicated. The broadcast service parameter message generator 36, shown in FIG. 1, amongst other things, provides for this differentiation.

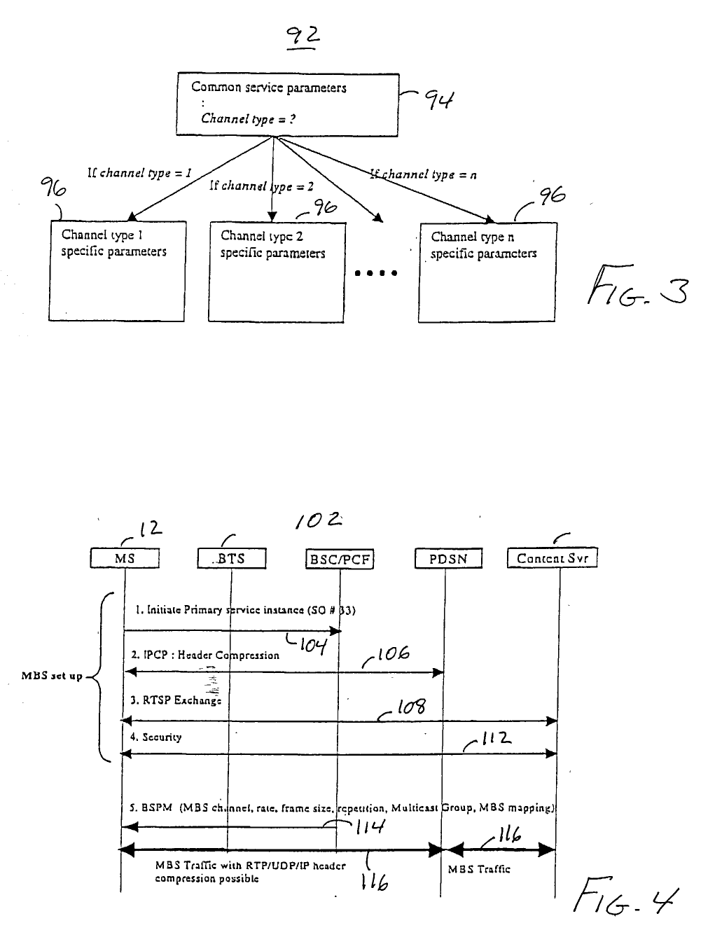

FIG. 3 illustrates the message structure, here shown generally at 92, of an exemplary message generated by the message generator 36, shown in FIG. 1. The message is here represented as being a multi-layered message having a common service parameter layer 94 and a channel-specific parameter layer 96. The layers 94 and 96 are also representative of fields into which the message is formatted.

The common-service parameters of the common-parameter layer include, for instance, parameters associated with multicast group information, mbs2bsr_id mapping information, MBS channel-type information, e.g., indications of the channel being a supplemental channel or a forward shared packet data channel, as well as any other parameters common to all of the channels.

The channel-specific parameters of the channel-specific layer 96 include, for a 1xEV-DV transport channel, MBS-channel Walsh code indications, data rate indications, MCS, or other coding level indications, frame size indications, and repetition number indications, as well as any other desired parameters, specific to a particular channel-type.

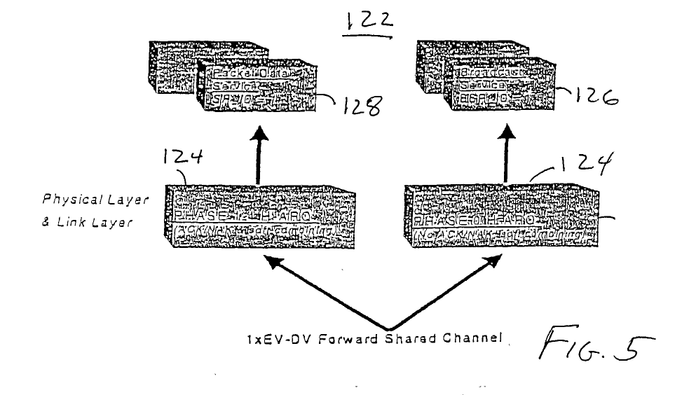

FIG. 4 illustrates a message sequence diagram, shown generally at 102, of an embodiment of the present invention. The message sequence diagram represents MBS set up and monitoring that is performed pursuant to an embodiment of the present invention.

First, and as indicated by the segment 104, a primary service instance, designated by the segment 104, is initiated by the mobile station. Segments 106, 108, and 112 are representative of MBS setup procedures, here a header compression, an RTSP exchange, and security signaling, respectively. The primary service instant initiation request generated by the mobile station is also generally considered to form part of the MBS setup.

Then, and as indicated by the segment 114, a broadcast service parameter message, is generated, here by the base station controller/packet control function 22 and sent to the mobile station. The message includes one or more of the common service parameters and channel-specific parameters. Thereafter, and as indicated by the segments 116, multibroadcast service traffic is effectuated between the data server 32 and the mobile station 12. RTP/UDP/IP header compression is here further shown to be utilized.

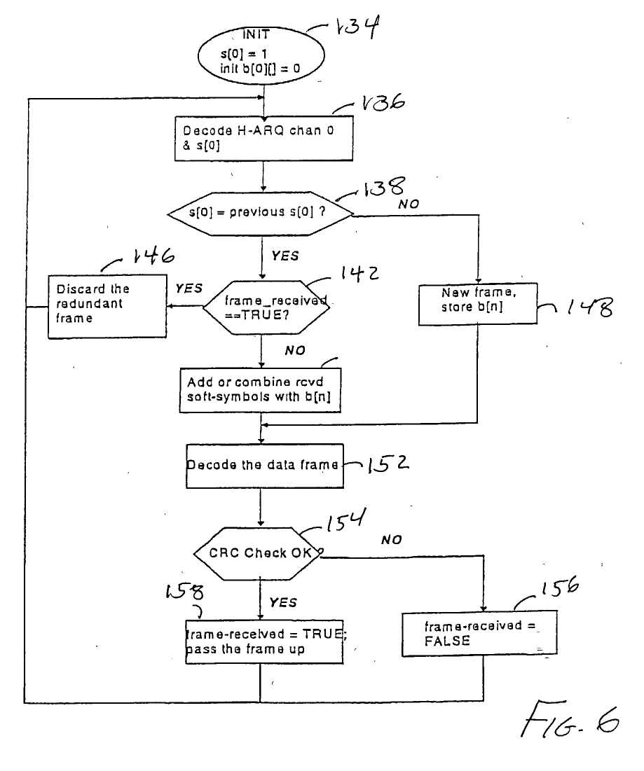

FIG. 5 illustrates a representation, here shown at 122, of the 1XEV-DV forward shared channel utilized MBS communication services in the communication system 10 shown in FIG. 1. Here, the physical and link layers 124 are designated. The right most (as shown) block representative of the physical and link layer represents a phase zero and the left most (as shown) of the designation of the physical and link layer 124 is here a phase 1-4 HARQ scheme. The phase zero HARQ scheme is used for the broadcast service, here indicated by the block 126 having a dsr_id equal to 1. And, the phase 1-4 HARQ mechanism is utilized for a packet data service, here designated by the block 128, in which the sr_id equals 1.

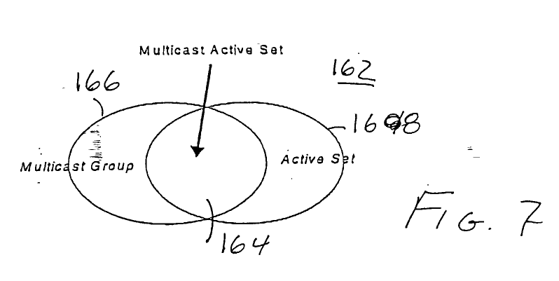

FIG. 6 illustrates a process diagram, shown generally at 132, representative of operation of the frame detector 48, shown in FIG. 1, forming a portion of the apparatus 34 of an embodiment of the present invention. The frame detector operates pursuant to a modified HARQ scheme in which data frames are selectably retransmitted to the mobile station. Various data structures are defined pursuant to operation of the communication of the frames to effectuate the MBS communication service. An indication of whether the frame has already been transmitted to an upper layer of the logical layers of the mobile station is formed. And, int s[0] equals one-bit H-ARQ channel sequence number, initialized, for instance, to n ‘1’. And, float space b[0] [interlever size] equals H-ARQ channel soft-symbol buffer, initialized to n ‘0’.

Initialization of the values of s[0]=1 and init b[0] equals zero is designated at 134.

Then, and as indicated by the block 136, the H-ARQ channel zero and the associated sequence number are decoded. Then, and as indicated by the decision block 138, a determination is made as to whether the sequence number corresponds to the previous sequence number. If the H-ARQ channel sequence number is the same value as the sequence number of a previous transmission, the yes-branch is taken to the decision block 142 whereat a determination is made as to whether the frame was passed to an upper logical layer. If not, the no branch is taken to the block 144 whereat the received soft symbols are added with soft symbols stored in a buffer, here designated at [b][n]. If conversely, the frame is determined at the decision block 142 already to have been passed to an upper logical layer, the yes-branch is taken to the block 146 and the frame, a redundant frame, is discarded. And, a branch is taken back to the block 136. If the no branch is taken from the decision block 138, the frame is considered to be a new frame, and the frame is buffered in the buffer designation b[n]. Such operation is indicated by the block 148.

Then, and as indicated by the block 152, the data frame is decoded. And, as indicated by the decision block 154, a determination is made as to whether the CRC (cyclic redundancy code) checks-out as being o.k. If not, the no branch is taken to the block 156, and a frame-received flag is set to false. And, conversely, if the CRC check, checks out, the yes-branch is taken to the block 158, and the frame received flag is set to a true value and the frame is forwarded to a higher logical layer.

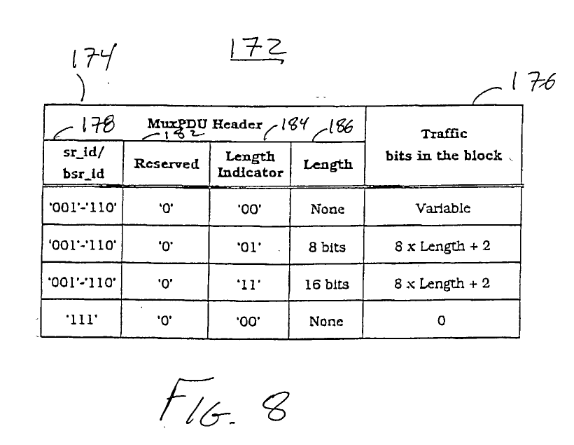

FIG. 7 illustrates a representation, shown generally at 162, of operation of the set comparator 52, shown at FIG. 1, also forming a portion of an embodiment of the present invention. The data comparator operates to permit selection at the mobile station of a base transceiver station of the network part to utilize who receives data communicated pursuant to the communication service. An added constraint in the communication system 10 is that the mobile station does not provide feedback information, for example, a carrier/interference ratio to the network part of the communication system to aid the network part to determine an eligible set of base transceiver stations for the mobile station to utilize. The forward shared channel uses an adaptive modulation and coding scheme (MCS) with different types of modulation. As there is no power control feedback provided by the mobile stations, the MCS is chosen, preferably, at a lowest-possible level to increase the data reliability. Here, a multicast active set 164, designated by the intersection of a multicast group 166 and an active set group 168. The active set of base transceiver stations are indicated by stored values, stored at the mobile station. And, the multicast group identifications are contained within a broadcast service parameter message generated by the generator 36, shown in FIG. 1.

Both the multicast and broadcast service and data/voice services are provided during operation of the communication system 10. Simultaneous effectuation of the separate communication services are supported. As noted with respect to the description of the multiplexer 82 shown in FIG. 2, the data forming the MBS data and the data/voice data, are processed separately. Data frames received upon an MBS channel are routed to the upper MBS instances.

MUX PDUs, used for the data instance, can be reused, but the front bits indicating the sr_id is used to identify the bsr_id.

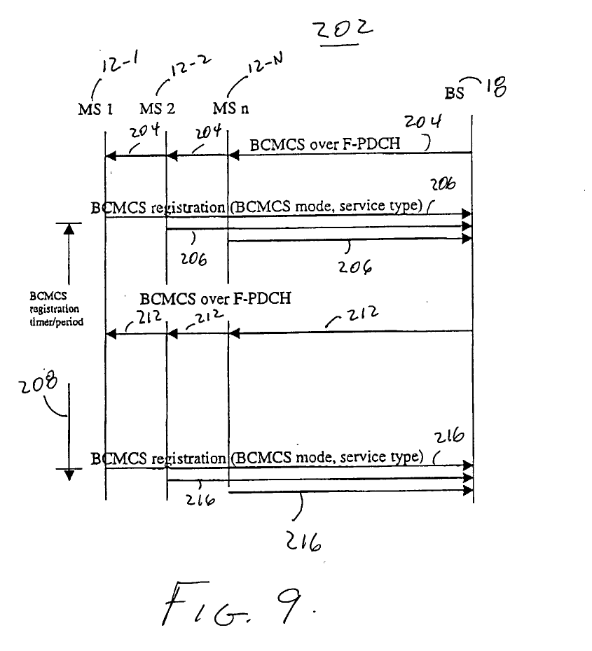

FIG. 8 illustrates an exemplary indication scheme forming a modified MUX PDU, here designated at 172. The MUX PDU includes a MUX PDU header portion 174 and a traffic portion 176. The parts of the header portion, here parts 178, 182, 184, and 186, are of values, as indicated in the figure, to cause the multiplexer of the mobile station to process the received data in an appropriate manner.

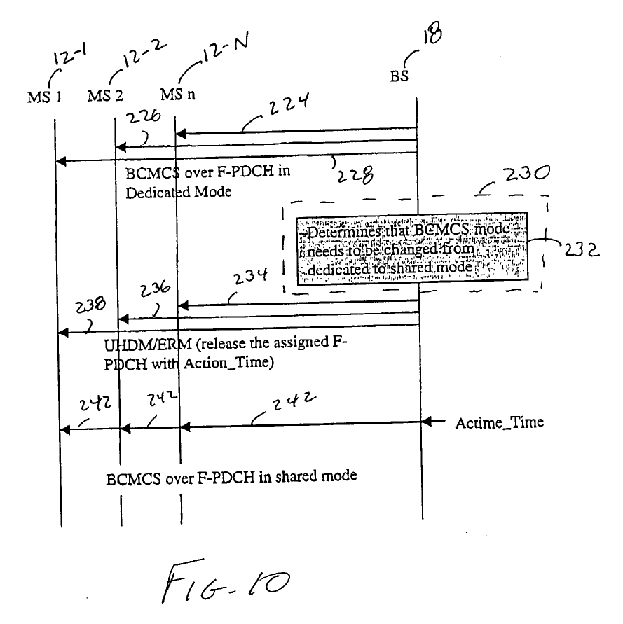

FIG. 9 illustrates a message sequence diagram, shown generally at 202, representative of messages generated during operation of another embodiment of the present invention. Here, again, a broadcast/multicast service (BCMCS) is effectuated with a plurality of mobile stations, here mobile stations 12-1, 12-2, . . . 12-n. The BCMCS is effectuated, again in a CDMA-based system that provides for 1xEV-DV communications. The BCMCS is, selectably, unidirectional and bi-directional. Unidirectional BCMCS does not require reverse-link feedback while bi-directional BCMCS requires reverse-link feedback.

First, and as indicated by the segment 204, the base transceiver station 18 is shown, initially, already to be broadcasting the BCMCS upon the forward packet data channel (F-PDCH). Each of the mobile stations 12-1 through 12-n are positioned to receive the data contained in the broadcast initialization. Each of the mobile stations, in turn, sends a BCMCS registration, indicated by the segments 206, that are returned to the base transceiver station. The BCMCS registration generated by the mobile stations provides registration information including, for instance, the BCMCS modes and service types that are associated with the respective mobile stations. The registration is repeated at a timed interval, here indicated by the interval 208.

Subsequent to registration of the mobile stations, the BCMCS service is effectuated, here, i.e., continued, indicated by the segments 212 by the base transceiver station to each of the mobile stations. The data forming the broadcast is transmitted on the F-PDCH. And, at the termination of the time period of the BCMCS registration time period, the mobile stations again generate BCMCS registrations, indicated by the segments 216. Again, the registrations include information including, for instance, the BCMCS modes and service types by which the mobile stations are respectively operable.

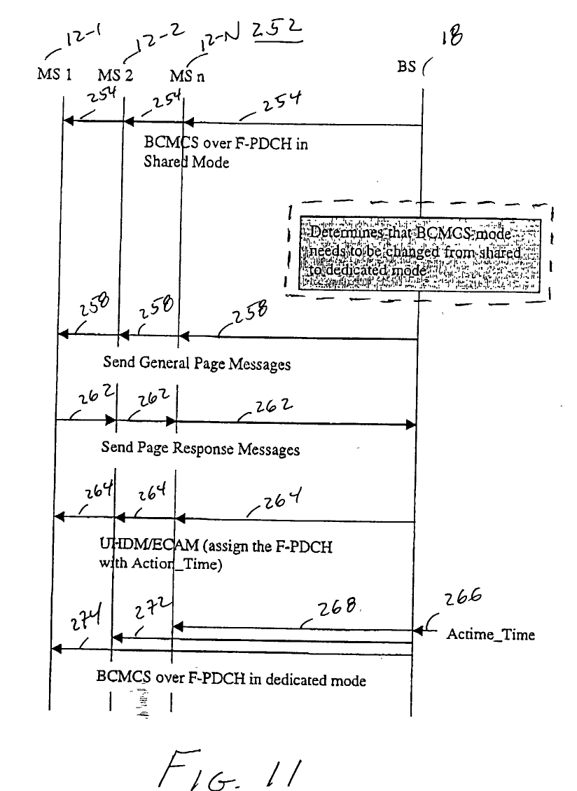

FIG. 10 illustrates a message sequence diagram, shown generally at 212, also representative of messages generated during another embodiment of the present invention. Here, again, broadcast and multicast services are effectuated with mobile stations. Here, 1xEV-DV F-PDCH BCMCS mode switching from a dedicated mode to a shared mode is represented.

Initially, and as indicated by the segments 224, 226, and 228, dedicated-mode BCMCS communications are effectuated by the base transceiver station 18 with individual ones of the mobile stations 12-1 through 12-n.

A determination is subsequently made by a selector 230, that the BCMCS mode is to be changed out of the dedicated mode and into a shared mode. The determination is indicated at the block 232, here carried out by the selector 230. Responsive to such determination, UHDM/ERM messages indicated by the segments 234, 236 and 238 are sent to respective ones of the mobile stations. The messages include a portion indicating release of the assigned F-PDCH together with an action_time indication thereof, e.g., the time at which the assigned F-PDCH channels with the respective ones of the mobile stations are to be released. And, thereafter, subsequent BCMCS broadcasts are broadcast in a shared mode upon the F-PDCH, indicated by the segments 242.

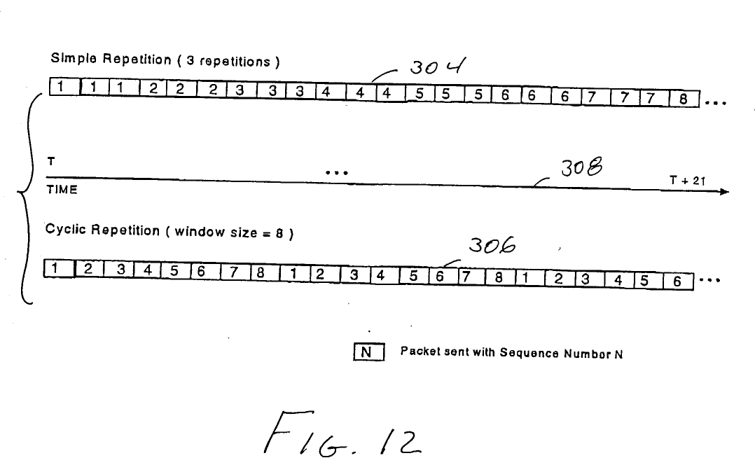

FIG. 11 illustrates a reverse scenario of a switchover out of a shared mode of operation and into a dedicated mode of operation. In the message sequence diagram, shown generally at 252, shared-mode broadcasts of the BCMCS, indicated by the segments 254, are sent upon the F-PDCH. Thereafter, and as indicated by the block 256, a determination is made at the selector 230 that the BCMCS mode of communication is to be changed out of the shared mode and into the dedicated mode. Responsive thereto, and as indicated by the segments 258, general page messages are sent to each of the mobile stations 12-1 through 12-n.

Responsive to detection of the general page messages at the individual ones of the mobile stations, page response messages are returned, indicated by the segments 262, to the base transceiver station. Thereafter, UHDM/ECAM messages are sent, indicated by the segments 264, to the mobile stations. The messages include assignation of the F-PDCH together with action times thereof. Thereafter, at the action time, indicated at the time 266, the dedicated-mode broadcasts of the BCMCS are communicated, in the dedicated mode, to the individual ones of the mobile stations, indicated by the segments 268, 272, and 274.

Also pursuant to an embodiment of the present invention, the reverse link feedback of 1xEV-DV is formed of a channel quality indication (CQI) and a fast physical layer H-ARQ ACK/NAK feedback.

As indicated by the message sequence diagram shown in FIGS. 9-11, 1xEV-DV BCMCS is sent by the base transceiver station to the mobile stations by way of the FPDCH in two separate modes. A shared mode is provided by which one specific and common mac_id is designated for one BCMCS session or logical channel. The base station delivers one BCMCS session indicated by the common mac_id. Mobile stations search for that common mac_id in order to receive the corresponding BCMCS. The mac_id is carried out on the packet data control channel, F-PDCCH, and BCMCS content traffic is carried on the packet data channel, F-PDCH. Physical layer H-ARQ ACK/NAK mechanisms are disabled when the communications are effectuated in the shared mode. And, a dedicated mode is provided. In this mode, the BCMCS content is delivered as a normal 1xEV-DV F-PDCH packet data. Each mobile station has a dedicated mac_id for BCMCS as well as other packet data services. The 1xEV-DV air interface protocol and scheme is, for instance, the same as provided in the CDMA 2000 revision C specification. The physical layer H-ARQ ACK/NAK mechanism is enabled in a dedicated mode. The 1xEV-DV-enabled mobile station is capable of receiving BCMCS data transmitted upon the F-PDCH when the mobile station is in the idle state, a PDCH control hold mode, or a PDCH active mode. And, when the mobile station is in the idle state and is receiving BCMCS upon the F-PDCH, then, there is no CQI feedback, nor is there physical A21 or ACK/NAK feedback, dedicated mac_id assigned to the mobile station, and the BCMCS serving mode is in the shared mode. When the mobile station is in a F-PDCH control hold mode or an F-PDCH active mode, and when the serving mode of the BCMCS is in a shared mode, then there is no CQI feedback if there is no other concurrent packet data service for the same mobile station. Also, there is no physical layer H-ARQ ACK/NAK feedback if there is no other concurrent packet data service for the same mobile station.

A mobile station that is to receive BCMCS service on the 1xEV-DV F-PDCH channel performs a time-based or periodic registration to the base station. The time-based, or periodic, registration is sent by way of an uplink layer-three message or a physical-layer signaling protocol. The time-based, or periodic, registration message includes a current mode or state of the mobile station parameter, e.g., idle, active, or control hold, as well as current service types, e.g., packet data and/or BCMCS.

Additionally, the 1xEV-DV base transceiver station is capable of utilizing the time-based, or periodic registration information from mobile stations to make decisions upon whether the F-PDCH BCMCS should be in a shared mode of operation or a dedicated mode of operation. The mode switch can be handled by the F-PDCH channel assignment or release messages with action_time. These pending messages specify the explicit switching time, action_time so that the mobile station is able to switch its monitoring mode at exactly the action time. And, the base transceiver station performs an algorithm of BCMCS mode selection based upon the number of mobile stations currently listening to the F-PDCH BCMCS and the state of the mobile station. For instance, if there are X mobile stations in an idle state, Y mobile stations in an F-PDCH control hold mode, and Z mobile stations in an F-PDCH active mode, and if aX+bY and cZ is less than a dedicated threshold, the base station commands, through appropriate signaling protocol, the mobile stations into the BCMCS dedicated mode. The dedicated threshold is a threshold number of dedicated-mode BCMCS users, and the values of a,b and c are waiting parameters.

Operation of a further embodiment of the present invention provides a repetition scheme capable of improving an overall frame error rate exhibited during effectuation of a BCMCS. A goal is to minimize mobile station transmissions in order to increase the longevity of the battery of the mobile station and to support a larger number of idle subscribers. If the mobile station has no active reverse link transmission while monitoring the F-PDCH, EV-DV H-ARQ protocols cannot be applied, i.e., no mobile station ACK/NAK. And, BCMCS data is likely to be transmitted at a constant transmit power as no mobile-station CQI report is provided. If the power budgeted is not enough for a desired quality-coverage level, multiple transmissions of the same BCMCS data frame is a possible solution. When the data frames are received, the duplicate frames are soft-combined to increase the transmit reliability.

Also, to enhance the F-PDCH BCMCS performance, soft/softer handoff is desirable in overlapped areas of different BTSs. To facilitate soft handoff, transmission of BCMCS data upon the F-PDCH should be synchronized in the largest-possible area. Autonomous, soft-handoff has the benefit of improving coverage without a corresponding signaling overhead. However, F-PDCH is shared amongst all of the packet data users within a corresponding sector so that synchronization between F-PDCHs from different sectors might not be possible. Each sector has its own traffic load, so it is difficult to schedule the data transmission at exactly the same time. Besides synchronization, soft/softer handoff has an additional implementation issue on the coordination of modulation in coding schemes amongst sectors of an active set. With these concerns, an EV-DV cell switching mechanism is needed for packet data services that can be utilized for BCMCS when the mobile station switches its data reception to a neighboring sector. Amongst the problems to effectuate such a scheme are how to monitor the BCMCS during the cell switching and how to continue the data reception subsequent to cell switching. Additional embodiments of the present invention facilitate resolution of this problem.

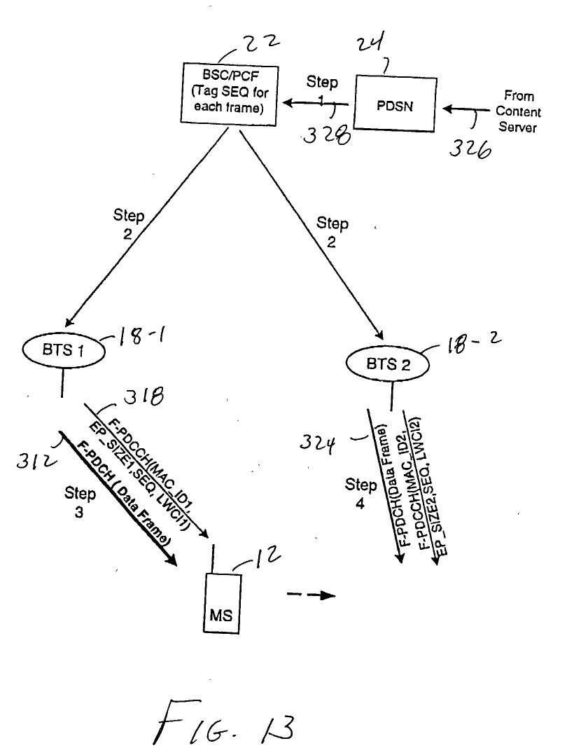

FIG. 12 illustrates a presentation, shown generally at 302, of a simple repetition scheme, 304, and a cyclic repetition scheme 306 over an interval of 21 time periods, indicated by the horizontal axis 308. The simple repetition scheme illustrates triplet repetitions of data frames while the cyclic repetition scheme shows cyclic repetitions with a window size of eight. That is to say, the simple repetition scheme 304 keeps repeating the transmission of the same data frame for a configurable number of times. And the cyclic repetition continues a sequential delivery with a window size of frames before the repetition scheme cycles back for another repeat. Both the window size and the number of repetition are configurable.

In order for the cyclic repetition scheme 306 to work well, the receiver needs a re-sequencing buffer of a buffer size up to the window size to store the received BCMCS data frames when the expected frame in front of the received frames is missing. Each BCMCS data frame also needs a sequence number so that the receiver can do data frame re-sequencing. The following fields carried in the forward packet data control channel F-PDCCH and used for H-ARQ are no longer meaningful with BCMCS. These fields are instead combined to form a five-bit sequence number field. The first two bits of the sequence number field are of an ACID (ARQ channel identifier) value, the subsequent two bits are of an SPID (subpacket identifier) value, and the final bit is of an ai_sn (ARQ identifier sequence number) value.

An exemplary SDU format transmitted in F-PDCCH for BCMCS is as follows:

A mac_id field is of an eight-bit bit length, an ep_size field is of a three-bit bit length, an SEQ field is of a five-bit bit length, and an LWCI field is of a five-bit bit length.

Radio transmission errors are, generally, of a bursty nature. When the radio conditions are poor, simple repetition has an increased possibility of loss of data as the repetitions of the transmission of the data frames are sequential, or in closer time slots. In contrast, cyclic repetition provides time diversity, albeit at increased complexity. Also, when the frame error rate is low, sequential transmission of the window size frames would deliver those data frames to a receiving application more quickly. BCMCS traffic is usually bursty, so cyclic repetition provides higher throughput, with less delay, when the radio conditions are good. Cyclic repetition also facilitates cell switching. The schemes exhibit backward capability.

Soft/softer handoff, cell-switching techniques used for EV-DV packet data services can also be utilized for high-speed BCMCS as synchronization and implementation issues are not involved. Before the procedure for monitoring the BCMCS data stream, various preparatory signaling must first be effectuated. For each BCMCS session, there is a BCMCS session identifier, bcmcs_id. And, for each base station, an mac_id specifies which BCMCS sessions are carried out upon the F-PDCH channels. The mac_id is a reserved, public ID. Using the public, mac_id value, multiple mobile stations are able to receive the same BCMCS data frame communicated upon the F-PDCH. The base station also assigns a unique bsr_id for each bcmcs_id. The set of these three values completely specify where to find, and to listen to, a given BCMCS at the base station.

An idle mobile station on the BCMCS monitors the serving sector for a specific set of these three values. When the monitored sectors no longer the best sector, the mobile station switches out of the serving sector into a new sector. After switching of the cells, the mobile station monitors the same BCMCS but uses a different set of the three values signaled for the new sector. Note that the bcmcs_id and the bsr_id values are the same, but the value of the ma_id might differ for the new sector.

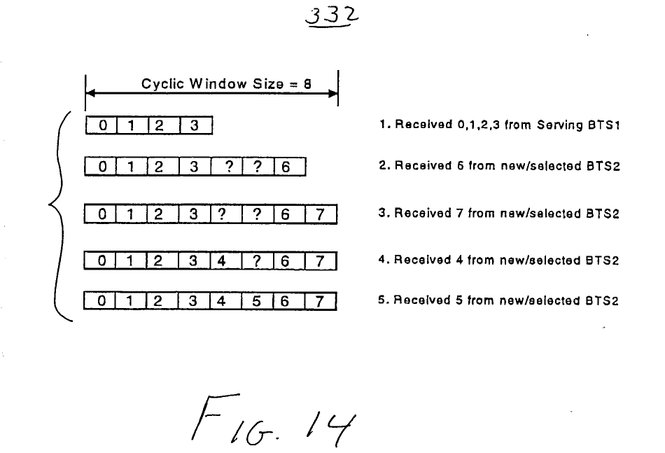

FIG. 13 illustrates monitoring by the mobile station 12 of the BCMCS data broadcast by the base transceiver stations, here the base transceiver stations (BTS 1 and BTS 2) 18-1 and 18-2. The figure also illustrates the BSC/PCF 22 and the PDSN 24. The mobile station monitors the BCMCS data during cell switching.

Each sector transmits a data frame over the F-PDCH with the accompanying information fields, such as the fields containing values of the mac_id, SEQ, ep_size and LWCI embedded in the F-PDCCH SDU. Such transmissions are indicated by the segments 318. As indicated by the segment 322, the mobile station monitors the data generated by the base transceiver station 18-1 with the mac_id1. If the mobile station selects the second base transceiver station 18-2 as the new sector, indicated by the segment 324, the mobile station thereafter monitors the same bcmcs_id data stream with the mac_id2.

Subsequent to the cell switching, fifty transmissions of the BCMCS data frames are synchronized, the mobile station is able to continue receiving the BCMCS data frames from the new sector without interruption. Implementation difficulties, however, exist. And, besides synchronization, BCMCS parameters for the new sector might not be available prior to the switching, causing an interruption of the data reception.

Through operation of a further embodiment of the present invention, a manner is provided by which to resume data reception in the event that there is interruption during the handoff. The sequence number field introduced for repetition can be used to continue the BCMCS after cell switching. However, the sequence number should be tagged at a higher network element (BSC) so that all of the sectors in the active set of the mobile station are unambiguously identified when the BCMCS data form arrives at the access network, indicated by the segment 326, from a content server (not shown in the figure). The base station controller tags each data frame for the bcmcs_id with a sequence number (SEQ) and forwards it to each sector, indicated by the segments 328. The sequence number has five bits so it wraps around at 32. Since the sequence number sent on the F-PDCCH is one per encoder packet, the BTS does not concatenate multiple BCMCS data frames into one F-PDCH SDU. After the mobile switches to the new sector, the mobile station is able to continue monitoring the same BCMCS data and resequence the data frames with its resequencing buffer.

FIG. 14 illustrates a cyclic repetition scheme, shown at 332, that facilitates recovery of data frames lost during cell switching. The cyclic window sizes is of an 8-frame size. As an example, here, the mobile station was expecting a frame with the sequence number of four from the first base transceiver station 18-1 prior to switching to the second base transceiver station 18-2. And, the mobile station receives sequence number 6 subsequent to the cell switching. If the repetition window size is 8, the mobile station is able to recover the frames four and five subsequent to receiving the frame 7. Thereby, the missing frames are recovered.

Thereby, through operation of an embodiment of the present invention, multicast and broadcast services are effectuated through the use of flexibly and dynamically defined, channels defined upon two or more transport channels. And, such services are effectuated, selectably, upon a shared channel or a dedicated channel. Also, a multiple-transmit scheme is provided to increase transmit reliability.

The previous descriptions are of preferred examples for implementing the invention, and the scope of the invention should not necessarily be limited by this description. The scope of the present invention is defined by the following claims:

We claim:

1. In a radio communication system at least selectably operable to effectuate a broadcast of data pursuant to a broadcast service to a first mobile station and at least a second mobile station, the radio communication system selectably defining a first transport channel and at least a second transport channel extending between network infrastructure of the radio communication system and the first and at least second mobile stations, an improvement of apparatus for facilitating communication of the data upon the first and at least second transport channels, said apparatus comprising:
a message generator coupled to the network infrastructure, said message generator for generating a broadcast service parameter message selectably for broadcast to the first and at least second mobile station, respectively, the broadcast service parameter-message selectably containing a common parameter field and a channel-specific parameter field, the common parameter field selectably populated with at least a first common-service parameter, common to the first and at least second transport channel and the channel-specific parameter field selectably populated with at least a first channel-specific parameter, common to less than all of the first and at least second transport channels.

2. The apparatus of claim 1 wherein the broadcast of the data effectuated by the radio communication system comprises a multicast and wherein the at least the first common-service parameter selectably contained in the broadcast service message formed by said message generator comprises a multicast group information parameter.

3. The apparatus of claim 1 wherein the broadcast of the data effectuated by the radio communication system comprises a multicast and wherein the at least the first communication-service parameter selectably contained in the broadcast service message formed by said message generator comprises a mapping parameter.

4. The apparatus of claim 1 wherein the broadcast of the data effectuated by the radio communication system comprises a multicast and wherein the at least the first communication-service parameter selectably contained in the broadcast service message formed by said message generator comprises a channel-type parameter.

5. The apparatus of claim 4 wherein the radio communication system defines a supplemental channel and wherein the channel-type parameter selectably contained in the broadcast service message formed by said message generator is of a first value to indicate the supplemental channel.

6. The apparatus of claim 4 wherein the radio communication system defines a forward-shared packet channel and wherein the channel-type parameter selectably contained in the broadcast service message formed by said message generator is of a first value to indicate the forward-shared packet channel.

7. The apparatus of claim 1 wherein the broadcast of the data effectuated by the radio communication system comprises a multicast, wherein the data is Walsh coded by a selected Walsh code, and wherein the first channel-specific parameter selectably contained in the broadcast service message formed by said message generator comprises a Walsh-code parameter.

8. The apparatus of claim 1 wherein the broadcast of the data effectuated by the radio communication system comprises a multicast and wherein the first channel-specific parameter selectably contained in the broadcast service message formed by said message or generator comprises a data-rate parameter.

9. The apparatus of claim 1 wherein the broadcast of the data effectuated by the radio communication system comprises a multicast and wherein the first channel-specific parameter selectably contained in the broadcast service message formed by said message generator comprises a coding-level parameter.

10. The apparatus of claim 1 wherein the data broadcast in the radio communication system is formatted into framer of a selected frame size and wherein the first channel-specific parameter selectably contained in the broadcast service message formed by said message generator comprises a frame-size parameter.

11. The apparatus of claim 1 wherein the data broadcast in the radio communication system is formatted into frames and broadcast pursuant to an H-ARQ (hybrid automatic request) acknowledgment scheme, said apparatus further comprising:
a frame transmitter for transmitting the frames pursuant to the broadcast of the data, said frame transmitter further for selectably retransmitting the frame pursuant to a network-initiated transmission command

12. In the radio communication system of claim 11, a further improvement of apparatus for each of the first and at least second mobile stations, said apparatus comprising:
a frame detector for detecting frames transmitted by said frame transmitter pursuant to the broadcast of the data, the frames having associated therewith sequence numbers identifying the frames, said frame detector further for identifying values of the sequence numbers associated with the frames detected thereat.

13. The apparatus of claim 12 further comprising a frame combiner coupled to said frame detector, said frame combiner selectably operable to combine the frames identified to have corresponding values of the sequence numbers.

14. The apparatus of claim 11 wherein the network-initiated retransmission command is generated according to an H-ARQ instance defined pursuant to the broadcast of the data.

15. The apparatus of claim 1 wherein the network infrastructure comprises a first set of base transceiver stations at which the broadcast of the data is effectuated, wherein each of the first and at least second mobile stations, respectively, maintains a listing of an active set of available base transceiver stations, and wherein each of the first and at least second mobile stations comprise:
a set comparator coupled to receive indications of the base transceiver stations of the first set of the active set, said set comparator for determining which of the base transceiver stations are members of both the first set and of the active set.

16. The apparatus of claim 15 wherein each of the first and at least second mobile stations further comprises a selector coupled to said set comparator, said selector for selecting at least one of the base transceiver stations, determined by said set comparator to be members of both the first set and of the active set, to which the time to receive the broadcast of the data.

17. In a method of communicating radio communication system at least selectably operable to effectuate a broadcast of data to a first mobile station and at least a second mobile station, the radio communication system selectably defining a first transport channel and at least a second transport channel extending between network infrastructure of the radio communication system and the first and at least second mobile stations, an improvement of a method for facilitating communication of the data upon the first and at least second transport channels, said method comprising:
selectably generating a broadcast service parameter message for broadcast to the first and at least second mobile stations, respectively, the broadcast service parameter message selectably containing a common parameter field and a channel-specific parameter field, the common parameter field selectably populated with at least a first common-service parameter, common to the first and at least second transport channel, and the channel-specific parameter field selectably populated with at least a first channel-specific parameter, common to less than all of the first and at least second transport channels.

18. The method of claim 17 wherein the radio communication system further provides for a nonbroadcast data service with the first mobile station simultaneous with the broadcast of the data thereto, said method further comprising the operation, at the first mobile station, of determining pursuant to which of the broadcast service and the nonbroadcast data service that data received thereat is associated.

19. The method of claim 18 wherein the data detected at the mobile station is formatted pursuant to a formatting scheme into data frames containing header parts and wherein said operation of determining determines to which of the broadcast services and the nonbroadcast service responsive to values of the header parts of the data frames.

20. The method of claim 19 wherein the header parts of the data frames are of first values when the data frames are generated pursuant to a broadcast data service and of second values when the data frames are generated pursuant to a nonbroadcast data service.

21. Ina radio communication system having network part and at least selectably operable to effectuate a broadcast of data pursuant to a broadcast service to a first mobile station and at least a second mobile station, an improvement of apparatus for facilitating the broadcast of the data, said apparatus comprising:
a selector coupled to the network part, said selector for selecting, responsive to a selection indicia, broadcast of the data in a selected one of shared mode and a dedicated mode, the shared mode of the broadcast formed by a single broadcast of the data to both of the first and at least second mobile stations, respectively, and the dedicated mode of the broadcast of the data addressed separately to the first and at least second mobile stations.

22. In a method for communicating in a radio communication system at least selectably operable to effectuate a broadcast of data pursuant to a broadcast service to a first mobile station and to at least a second mobile station, an improvement of a method for facilitating the broadcast of the data, said method comprising:
selecting, responsive to a selection indicia, broadcast of the data in a selected one of a shared mode and a dedicated mode;
broadcasting the data in a shared mode if selection is made during said operation of selecting to broadcast the data in the shared mode; and otherwise
broadcasting the data in a dedicated mode.

23. In a radio communication system having a network part and at least selectably operable to effectuate a broadcast of data pursuant to a broadcast service to a first mobile station and to at least a second mobile station, the data formatted into a sequence of data frames, the sequence including a first data frame and at least a second data frame, an improvement of apparatus for facilitating the broadcast of the data, said apparatus comprising:
a selector coupled to the network part, said selector for selecting, responsive to a selection indicia, a repetition scheme by which to repeat broadcast of the first data frame and the at least the second data frame, the repetition scheme a selected one of a cyclic repetition pattern and a simple repetition pattern.

24. In a method for communicating in a radio communication system having a network part and at least selectablay operable to effectuate a broadcast of data pursuant to a broadcast service to a first mobile station and to at least a second mobile station, the data formatted into a sequence of data frames, the sequence including a first data frame and at least a second data frame, an improvement of a method for facilitating the broadcast of the data, said method comprising:
selecting, responsive to a selection indicia, a repetition scheme by which to repeat broadcast of the first data frame and the at least the second data frame, the repetition scheme a selected one of a cyclic repetition pattern and a simple repetition pattern;
broadcasting the data pursuant to the cyclic repetition pattern if selection is made during said operation of selecting to repeat broadcast of the data frame pursuant to the cyclic repetition pattern; and otherwise
broadcast the data pursuant to the simple repetition pattern.
